(19) United States
(12) Patent Application Publication
(10) Pub. No.: US 2012/0203621 A1
(43) Pub. Date: Aug. 9, 2012

(54) METHOD FOR DEVELOPING SALES FOR PROMOTIONAL PRODUCTS

(75) Inventor: Ronald A. Williams, Edgerton, MN (US)

(73) Assignee: Fey Industries, Inc., Edgerton, MN (US)

(21) Appl. No.: 13/367,912

(22) Filed: Feb. 7, 2012

Related U.S. Application Data
(60) Provisional application No. 61/440,186, filed on Feb. 7, 2011.

(51) Int. Cl. G06Q 30/02; G06Q 30/06

(52) U.S. Cl. 705/14.39; 705/14.72

(57) ABSTRACT

A method is presented for developing sales for promotional items. One or more educational videos are created for one or more promotional items. The educational videos are used as content on one or more web pages that provide information for the promotional items. The web pages are included on a website for the promotional items. Distributor contact information is received from a distributor. The distributor contact information is included on at least one of the web pages, such that a viewer of the website can contact the distributor.

### BACKGROUND

Promotional products provide an easy and inexpensive way for companies to call attention to their products and services. The promotional products, such as pens, binders, calendars, coffee mugs, caps, etc. are typically imprinted with the name and logo of a company and given to customers free of charge as a way of promoting sales.

A wide range of promotional products are available for companies to choose from. Companies may learn about the promotional products available through one or more commonly available websites that describe these products. The websites are available from a number of sources including suppliers who manufacture the promotional products, distributors who work with one or more manufactures and with companies who buy the promotional products and from trade groups that promote these products.

Typically, companies select and obtain promotional products from a distributor who in turn sources the promotional products from a supplier. The supplier manufactures and/or decorates the promotional products and typically works with a distributor network. Because the supplier manufacturers the promotional products, the supplier is very knowledgeable about types of products available, their use and impact on sales, their manufacturing methods, etc. However, this supplier information may not always be available or communicated to those considering the purchase of these promotional products.

### SUMMARY

Embodiments of the disclosure are directed to a method implemented on a computing device for developing sales for promotional products. The promotional products may be manufactured and/or imprinted with advertising information. One aspect involves the creation of educational videos for the promotional products. The educational videos are included as content on one or more web pages that provide information, uses, applications and benefits for the promotional products. The web pages are included on a website for the promotional products.

Another aspect involves receiving distributor contact information from a distributor. The distributor information is incorporated on at least one of the web pages. A link address is obtained for the website for the promotional products. The link address corresponds to a home web page for the website. The link address is sent to the distributor. One or more orders are obtained from the distributor for the promotional products.

In yet another aspect, the web pages do not include any information identifying the creator of the educational videos and the web pages do not include any information identifying a supplier or manufacturer of the promotional products.

Another aspect is a method for developing sales for promotional items, the method comprising: receiving with a computing device one or more educational videos for one or more promotional items available from a supplier; using the educational videos as content on one or more web pages that provide information for the promotional items, the web pages being included on a website for the promotional items; receiving distributor contact information from a distributor; and incorporating the distributor contact information on at least one of the web pages, such that a viewer of the website can contact the distributor.

A further aspect is a method for developing sales for promotional items, the method comprising: sending distributor contact information to a first electronic computing device; receiving from the first electronic computing device a link address to a website that includes information for the promotional items available from a supplier, and includes the distributor contact information; sending the link address to a second electronic computing device; and receiving from the second electronic computing device an order for a promotional item.

### DESCRIPTION OF THE DRAWINGS

FIG. 1 shows an example system that supports a method for developing sales for promotional products.

FIG. 2 shows an example promotional products private-labeled web page.

FIG. 3 shows an example binders product private-labeled web page.

FIG. 4 shows an example insurance industry products private-labeled web page.

FIG. 5 shows an example promotional products generic web page.

FIG. 6 shows an example binders product generic web page.

FIG. 7 shows an example insurance industry products generic web page.

FIG. 8 shows an example flowchart for developing sales for promotional products from the supplier computer of FIG. 1.

FIG. 9 shows an example flowchart for developing sales for promotional products from the distributor computer of FIG. 1.

FIG. 10 shows an example flowchart for developing sales for promotional products from the advertiser computer of FIG. 1.

FIG. 11 shows example components of the supplier computer of FIG. 1.

### DETAILED DESCRIPTION

The present application is directed to systems and methods for developing sales for promotional products via educational videos on a website. In some embodiments, promotional products have the name and logo of a company or organization imprinted on them and are given to customers of the company, typically free of charge, as a way to promote a company's brand, goodwill services and/or sales of the company's products. In this disclosure, companies that purchase promotional products for their customers or prospective customers are referred to as advertisers, companies or individuals that manufacture the promotional products are referred to as suppliers and companies or individuals that act as interfaces between suppliers and advertisers are known as distributors. In this disclosure, references to companies also apply to organizations. In this disclosure, references to customers may also apply to prospective customers. The educational videos provide a means to educate advertisers about the promotional products. Because the suppliers are often most knowledgeable about the products they manufacture, the educational videos are typically created by the suppliers. However, because sales are typically made via distributors, supplier contact information does not appear on the website. Instead, distributor contact information may be provided on the website.

A distributor of the promotional products directs advertisers to the website by providing a link address for the website. When an advertiser accesses the website, the advertiser may view one or more of the educational videos on the website and learn about the promotional products that are available. Other means are possible for directing advertisers to the website. For example, advertisers may be directed to the website by the scanning or capturing of barcodes (e.g., EZcode matrix barcode using the ScanLife scanner software, or other barcodes, such as 2D barcodes, 3D barcodes, QR codes, Microsoft Tags, or similar technologies. In examples, distributors may also be directed to educational video websites using these barcode technologies.

When the advertiser decides to purchase a promotional product, the advertiser is able to contact the distributor and make a purchase. The advertiser is able to learn about the promotional product from the educational videos provided by the supplier, but the advertiser does not learn the name of the supplier from the website and is not able to contact the supplier directly from the website. In this manner, by directing advertisers to the website, the distributor is able to provide better information about the promotional products and still be involved in the sales of the promotional products.

Another advantage of using educational videos in the manner described is that it helps to preserve the business model currently used in the promotional products industry in which a product is sold through a value-added reseller. It also helps to preserve and maintain relationship integrity between suppliers and distributors and between distributors and advertisers.

As used in this disclosure, promotional products are a type of promotional item. Promotional products are typically relatively low cost items that are often given away for free by an advertiser as a way to promote sales, improve good will or increase brand recognition. Other types of promotional items may include higher dollar items such as incentives or premiums. For example, a customer may receive a premium item, for example a camera or a blender, for opening up a checking account. A customer may receive an incentive item to affect an individual's behavior, such as to work safer or sell more. Business forms are another type of promotional item. Additional types of promotional items are possible. Any of the promotional products discussed herein can, in another embodiment be a promotional item.

In this disclosure, references to distributors may also apply to service providers. A service provider is a third-party entity that provides product and pricing information for promotional products, typically via a website. One example of a service provider is Advertising Specialty Institute (ASI), of Trevose, Pa. In another possible embodiment, the web pages, videos, and/or content described herein may be provided by a service provider, and may be branded with the name of the service provider in some embodiments. Additional branding to identify the distributor(s) can also be provided in some embodiments, as discussed herein.

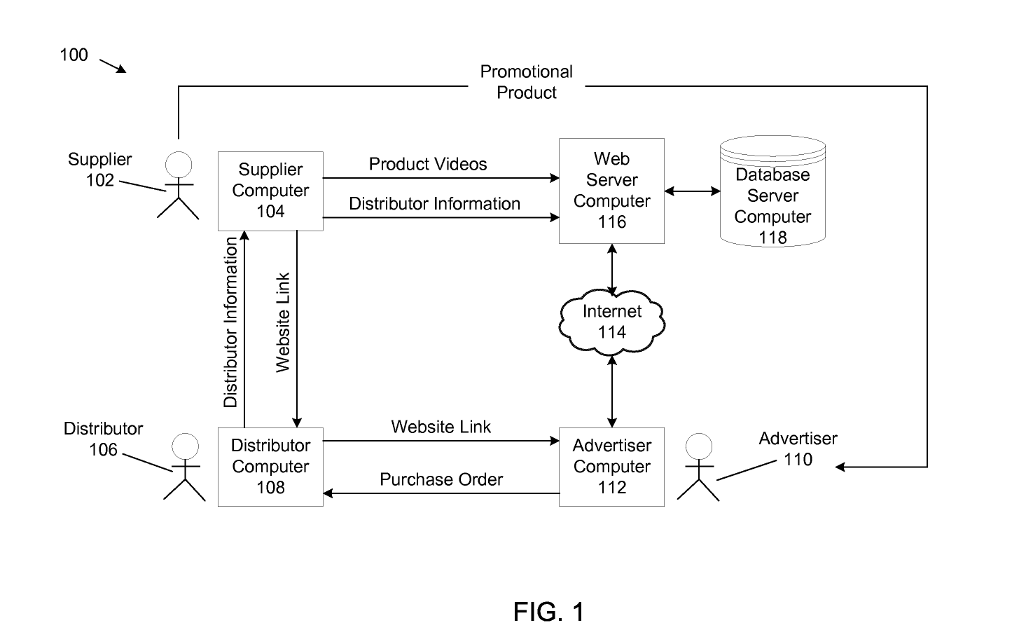

FIG. 1 shows an example system 100 in which sales can be developed for promotional products via educational videos on a website. The example system 100 includes a supplier 102, a supplier computer 104, a distributor 106, a distributor computer 108, an advertiser 110, an advertiser computer 112, an Internet network 114, a web server computer 116 and a database server computer 118.

The example supplier 102 is a manufacturer of promotional products. Promotional products are products like pens, binders, calendars, caps, coffee mugs, etc. in which a company's name and logo are imprinted and which are typically given to the company's customers free of charge as part of promotional advertising.

The example supplier computer 104 is typically a client computer, for example a PC that is accessible by the supplier 102. The supplier computer 104 may contain one or more videos relating the promotional products manufactured by the supplier. In examples, the videos may be stored on a server computer or on a database server. The system 100 shows one supplier and supplier computer. However, in examples more than one supplier or supplier computer may be used.

The example distributor 106 is a distributor of promotional products. The distributor 106 may have associations with many suppliers, often hundreds of suppliers, that manufacture promotional products. The distributor 106 may also have accounts with many advertisers who purchase promotional products. Typically, an advertiser uses a distributor to recommend, source and purchase promotional products. Because distributor 106 receives a profit markup on promotional products purchased by an advertiser through distributor 106, distributors like distributor 106 are very guarded about having advertiser's deal directly with suppliers. For this reason, the product videos on web server computer 116 are supplier neutral, in that the product videos typically do not include any references to suppliers.

The example distributor computer 108 is a client computer, for example a PC that is accessible by the distributor. The distributor computer 108 stores information regarding supplier 102 and advertiser 110. Example information stored on the distributor computer 108 includes contact information for supplier 102 and any other suppliers with which distributor 106 has an association and contact information for advertiser 110 and any other advertisers with which distributor 106 has an association. The distributor computer 108 also stores a link address to a private-labeled website, for example web server computer 116 on which promotional videos are hosted for the distributor 106. Other information may be stored on distributor computer 108.

The example advertiser 110 is typically a company that uses or has a desire to use promotional products. The promotional products are typically given away free to the customers of the company to promote business. The company may be in one of several industries. Some industries that use promotional products are automotive, education, hospitality, insurance, not-for-profit, government, real estate, manufacturing, construction, health, banking and restaurant. Other industries are possible.

The advertiser 110 may have an account with a distributor, such as distributor 106, who has access to promotional products. Whereas advertiser 110 may be able to view promotional products directly from a supplier, for example from a supplier's website, many advertisers want to work through distributors. Advertisers who purchase a large amount of promotional products may have a dedicated sales person with the distributor company that can recommend specific products, any questions, and deal with any problems that may arise during or after a purchase. Similarly, distributors try to cultivate relationships with advertisers because the distributors typically receive a good profit on promotional products sold to an advertiser through a distributor. In addition, in an effort to support a distribution channel, suppliers typically prefer not to interact directly with the advertiser 110, preferring to deal directly with the distributer 106 instead, and as a result the advertiser may not be able to purchase promotional products directly from the supplier 102 without going through the distributer 106.

The example advertiser computer 112 is a client computer, typically a PC that is accessible by the advertiser 110. The advertiser computer 112 includes a web browser that permits the advertiser 110 to access web server computer 116 and view videos of promotional products accessible from web server computer 116. The advertiser computer 112 accesses web server computer 116 via a network such as the Internet 114.

The example web server computer 116 is a server computer that includes web hosting software. One or more websites may be hosted on web server computer 116. Each website hosted on web server computer 116 has a specific Uniform Resource Locator (URL) associated with it, in some embodiments. One or more of the websites hosted on web server computer 116 provide videos for promotional products. Typically, one or more of the websites hosted on web server computer 116 are private-labeled websites that provide promotional videos but that are also tied to a specific distributor, that provide distributor contact information and that typically provide a means, for example an email link, for contacting the specific distributor via the website. However, the private-labeled websites do not provide any supplier information. All communication is between the advertiser and the distributor. Other means for contacting the distributor are possible, for example using barcode technologies such as described herein.

In addition to private-labeled websites, one or more of the websites hosted on web server computer 116 may be a generic website. The generic website provides promotional videos but does not provide any information regarding the supplier or the distributor of the promotional products shown on the website.

The product videos made available on the web server computer 116 are typically provided by the suppliers. The product videos are typically educational in nature and because the supplier knows the product best, the supplier can do a good job in educating the advertiser about the product. Depending on the number of videos provided by the supplier, one or more of the videos may be stored on a database server computer, for example database server computer 118, rather than on web server computer 116. An example database server is the Microsoft SQL Server® 2008 database server from Microsoft Corporation or Redmond, Wash.

Referring again to FIG. 1, in an example sequence of events, the distributor 106 sends distributor information from the distributor computer 108 to the supplier computer 104. The example distributor information includes the name, mailing address, email address and phone number of the distributor 106. The distributor information may also include a logo associated with the distributor.

In examples, the supplier computer 104 sends the distributor information to the web server computer 116. The supplier computer 104 also sends one or more product videos to the web server computer 116. In other examples, instead of sending actual product videos, the supplier computer 104 may send a link to product videos to the web server computer 116. For example, the product videos may be stored on database server computer 118 and the link provides access to one or more product videos stored on database server computer 118. In still other examples, the distributor information is embedded into and included in the product videos.

The supplier computer 104 sends a message to distributor computer 108 that includes a link address (typically a URL) to a website on web server computer 116 that stores the product videos for the distributor 106. This link address is in effect a link to a private-labeled website for distributor 106. The distributor computer 108 sends the website link address to advertiser computer 112.

The advertiser 110 accesses the private-labeled website specified by the link address and views one or more videos describing promotional products. When the advertiser 110 decides to purchase one or more promotional products, the advertiser contacts the distributor and submits a purchase order to the distributor 106. The distributor 106 then submits a purchase order to the supplier 102 to ship the ordered product to the advertiser 110, and the supplier 102 makes the shipment of the promotional product directly to the advertiser 110. Alternatively, the supplier 102 may ship the ordered product to the distributor 106. These aspects are discussed in more detail in the following drawings.

In another embodiment, the display of promotional product information can be provided to an advertiser 110 through a software application running on a mobile computing device 112, rather than through web pages displayed through a browser. In this example, the information described herein as being displayed on a web page, is instead displayed in a display page of the software application on the mobile computing device. The product information may still be provided by a Web server computer 116, or alternatively may be stored directly in the software application on the advertiser computer 112.

In some embodiments, rather than providing a link to a web site where promotional product information is displayed, the link can instead be a link to download the software application.

In yet another possible embodiment, the link can be an identifier, such as a part number, that identifies the promotional product. The identifier can be provided to the software application to cause the software application to display the information about the promotional product. The identifier can alternatively be a distributor identifier that is associated with the distributor contact information. Upon receipt of the identifier by the software application on the advertiser computing device 112, the software application modifies the display pages to contain the distributor contact information. The distributor contact information can be retrieved from the web server computer 116, for example, by sending the distributor identifier to the Web server, which in turn sends the distributor contact information to the advertiser computer 112.

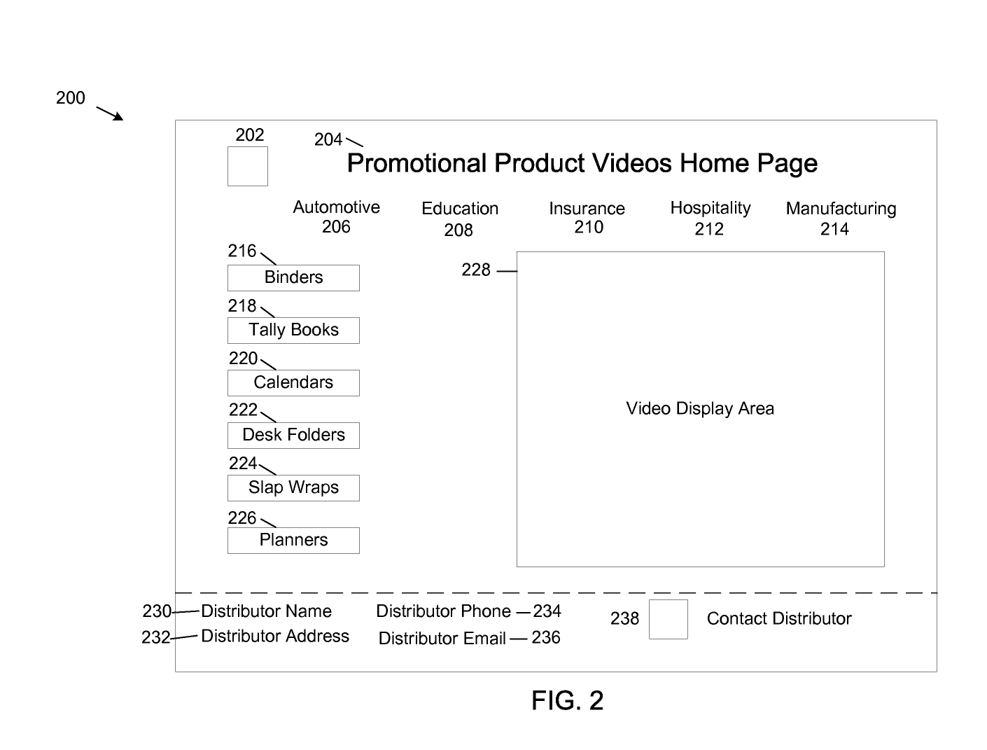

FIG. 2 is an example promotional products video web page 200. The example web page 200 is rendered when an advertiser, for example advertiser 110, accesses a private-labeled website on web server computer 116 via the website link address provided by distributor computer 108. The web page 200 is a private-labeled web page that includes distributor information. The example distributor information includes a distributor logo 202 and distributor contact information. Distributor contact information includes the distributor name 230, distributor address 232, distributor phone 234 and distributor email 236. In addition, the web page 200 includes a button 238 that the advertiser can click to contact the distributor, typically via email.

The web page 200 includes a video display area 228. When the web page 200 is rendered, a video starts playing in the video display area 228. The video that starts playing in the video display area 228 typically provides educational information about the benefits of using promotional products and may discuss the types of promotional products available and industries in which promotional products may be used and are available. The video may also include a voice-over by a distributor in which the distributor may provide additional comments about the promotional products and/or make a sales pitch for the promotional products.

Across the top of the web page 200 are links to industry pages that provide videos for promotional products for specific industries. For example, web page 200 includes links for the automotive, education, insurance, hospitality and manufacturing industries. In examples, other industries may be linked from the web page 200. For example, when an advertiser clicks on the example insurance link 210, a web page providing videos pertaining to the insurance industry is rendered, as discussed later in this disclosure. Similar industry specific web pages are rendered when an advertiser clicks automotive link 206, education link 208, hospitality link 212 and manufacturing link 214. In other examples, drop-down menus, selectable buttons or other user interface elements can be used instead of links to receive user input and perform the associated action.

Across the left side of the example web page 200, are product category buttons, including the example binders button 216, tally books button 218, calendars button 220, desk folders button 222, slap wraps button 224 and planners button 226. Other buttons and additional buttons may be rendered on web page 200. Each button brings up a web page with videos specific to the product category selected. In this manner, the example promotional product videos web page 200 provides two ways for a user to render information—via an industry selection or via a product category selection.

The example web page 200 may also includes other educational information besides videos. For example, the web page 200 may include research and statistics on promotional products. In addition, the web page 200 may include one or more links that enable educational videos to be shared by linking to third-party social networks like Facebook or Twitter.

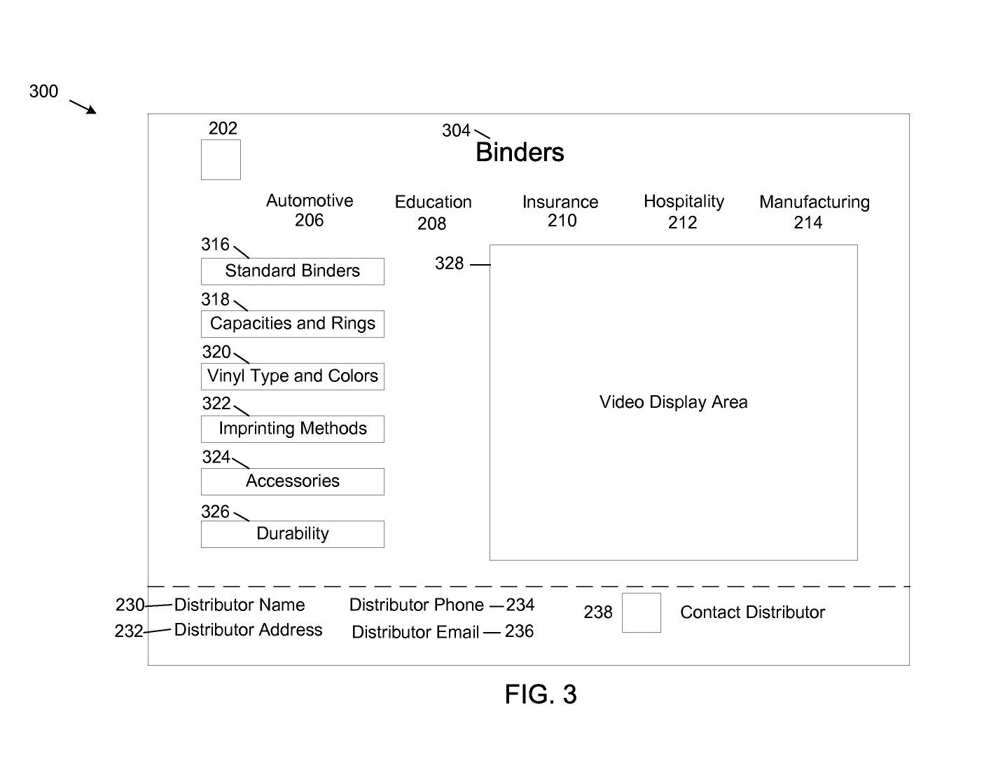

FIG. 3 shows an example private-labeled web page 300 that provides information on binders. The example web page 300 is rendered when a user clicks on the binders button 216 on web page 200. When the web page 300 is rendered, a video relating to binders starts to play on a video display area 328. The video that starts to play when the web page 300 is rendered is typically an educational video that summarizes the binder promotional products available and describes that describes the benefits of the binder promotional products.

Along the left side of the web page 300 are a series of buttons 316-326 that pertain to specific topics relating to binder promotional products. When one the buttons 316-326 are clicked, an educational video corresponding to the selected topic starts playing in the video display area 328. The example web page 300 can show videos describing standard binders (button 316), the available capacities and rings of available binders (button 318), binder vinyl types and colors (button 320), binder imprinting methods (button 322), binder accessories (button 324) and binder durability (button 326). More or fewer topics and corresponding buttons may be included on the web page 300. The intent of each video is to educate the viewer of the web page so that the viewer understands the binder product offerings and the benefits associated with the product offerings.

The example web page 300 also includes the same private-labeled distributor information as rendered on web page 200. For example web page 300 includes the distributor logo 202, distributor contact information 230, 232, 234 and 236 and a contact distributor button 238. The web page 300 also includes the same industry links as rendered on web page 200, including automotive 206, education 208, insurance 210, hospitality 212 and manufacturing 214. When an advertiser decides to purchase one or more binder products or has a question to ask, the advertiser can contact the distributor using the contact information 230-236 or the contact distributor button 238.

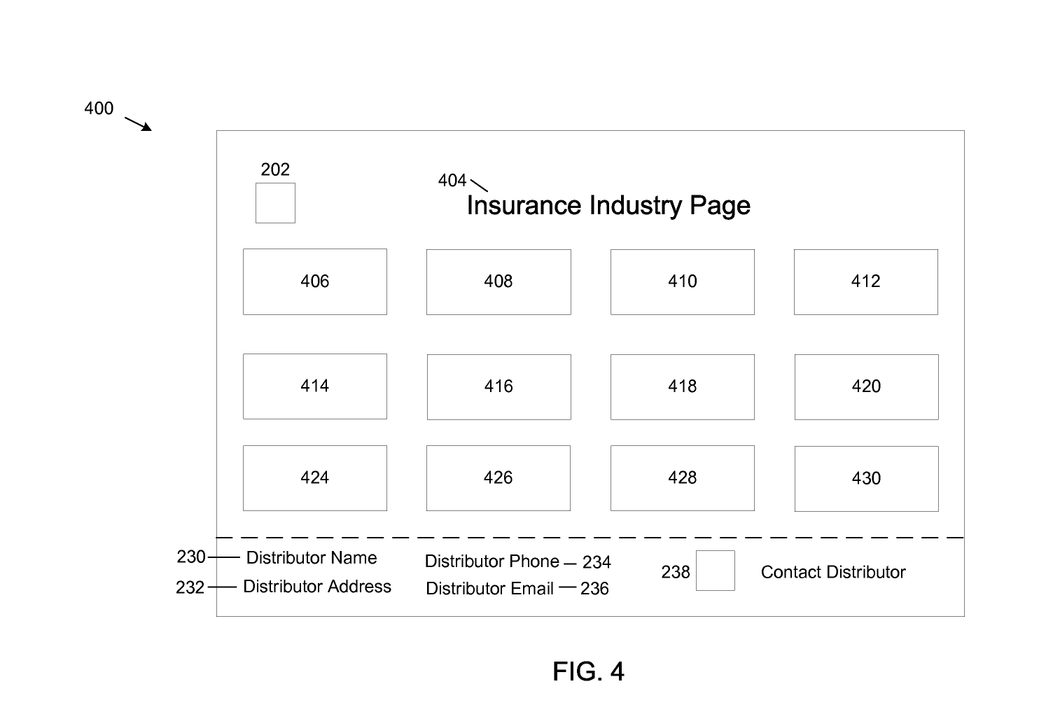

FIG. 4 shows an example industry links web page 400 for the insurance industry. The example industry links web page 400 is rendered when a user selects the insurance link 210 from the promotional products web page 200. Alternatively, the insurance link 210 may be selected from the any product specific web pages that include industry links, for example by selecting the insurance link 210 from the binders web page 300.

The insurance industry links web page 400 includes example snapshots 406-430 of educational videos relating to the insurance industry. Each snapshot 406-430 shows one still frame of the corresponding educational video. When the snapshot is clicked, a product web page that includes the video is rendered and the video starts playing on the product web page. For example, if snapshot 418 is related to a particular type of binder, the video starts playing on the example video display area 328 on web page 300. Thus, one can be directed to a products web page from either the promotional product videos web page 200 or from one of the industry links pages, in this example from web page 400.

The example insurance industry links page 400 also includes the same private-labeled distributor information as rendered on web page 200. For example web page 300 includes the distributor logo 202, distributor contact information 230, 232, 234 and 236 and a contact distributor button 238. The web page 300 also includes the same industry links as rendered on web page 200, including automotive 206, education 208, insurance 210, hospitality 212 and manufacturing 214.

The example web pages shown in FIGS. 2, 3, and 4 are typically constructed from web templates. Some examples of web templates are a Hypertext Markup Language (HTML) template, an Active Server Pages (ASP) template, a flash template, and a content management system template. For the private-labeled web pages shown in FIGS. 2, 3, and 4, the top section of each web page is sometimes known as a masthead and the bottom portion is sometimes known as a footer. For example, the web page 200, the logo 202 and the “Promotional Product Videos Home Page” banner are part of the masthead. Similarly, distributor contact information, including distributor name 230, distributor address 232, distributor phone 234, distributor email 236 and contact distributor button 238 are part of the footer. In this example, templates are also used for other sections of web page 200, for example the video display area 228. When the web pages are constructed, educational videos stored on web server computer 116 or on database server computer 118 are typically obtained and embedded into an appropriate template on a web page.

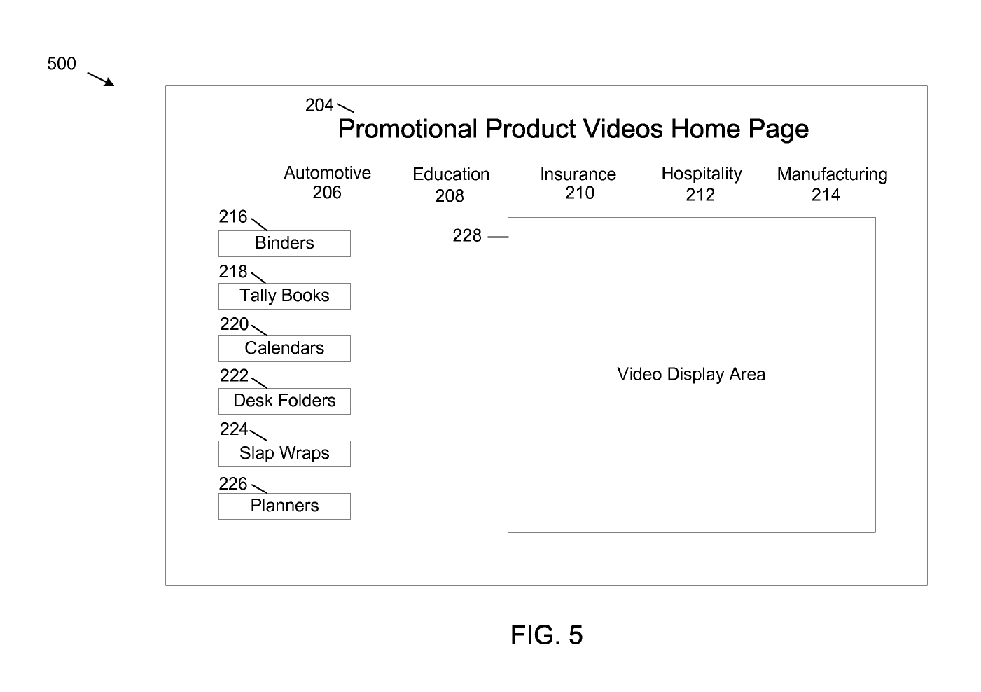

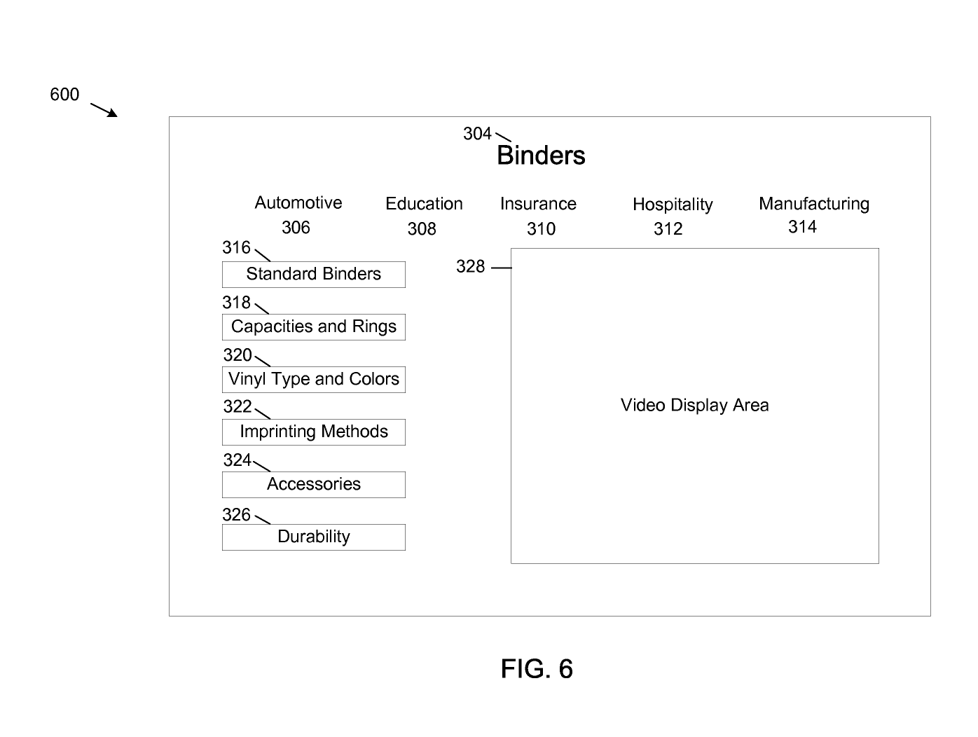

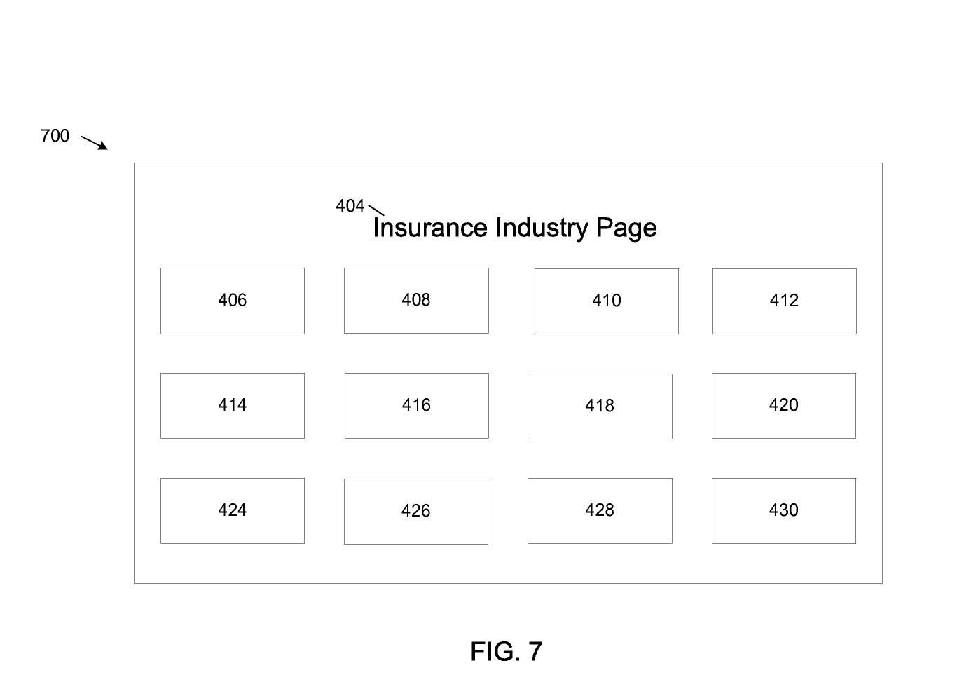

FIGS. 5, 6 and 7 shows generic web pages that correspond to the private labeled web pages shown in FIGS. 2, 3 and 4, respectively. For example, FIG. 5 shows a generic page 500 of a promotional products video home page, FIG. 6 shows a generic page 600 of a binders product page and FIG. 7 shows a generic page 700 of an insurance industry links web page. The generic web pages are identical to the corresponding private labeled web pages except that the generic web pages do not include distributor information.

The generic web pages shown in FIGS. 5, 6 and 7 may be used by advertisers that do a search for promotional products on an Internet search engine. The intent of the generic web pages is to educate the advertisers on the benefit on of using promotional products and to show the advertisers some sample products that are available. When an advertiser determines that the advertiser wants to purchase one or more promotional products, the advertiser can do additional research to determine how and where to purchase such products. In some examples, one or more of the generic web pages may include a link to a web page showing distributors that can be used to purchase the promotional products shown on the generic web pages. Alternatively, some distributors that do not have private labeled web pages may send a link for the generic web pages to an advertiser. The advertiser would then contact the distributor who sent the link when the advertiser makes a determination to purchase one or more promotional products from the generic web pages. As an additional alternative, the distributor may include the link to the generic web page on the distributor's website.

In some examples, the example generic web pages shown in FIGS. 5, 6 and 7 are used to create the private-labeled web pages of FIGS. 2, 3 and 4, respectively. In these examples, the private-labeled web pages use the generic web pages as a base and incorporate distributor information to the generic web pages at runtime when the private-labeled web pages are rendered. In other examples, the private-labeled web pages are stored statically incorporating the content of the generic web pages and the distributor information.

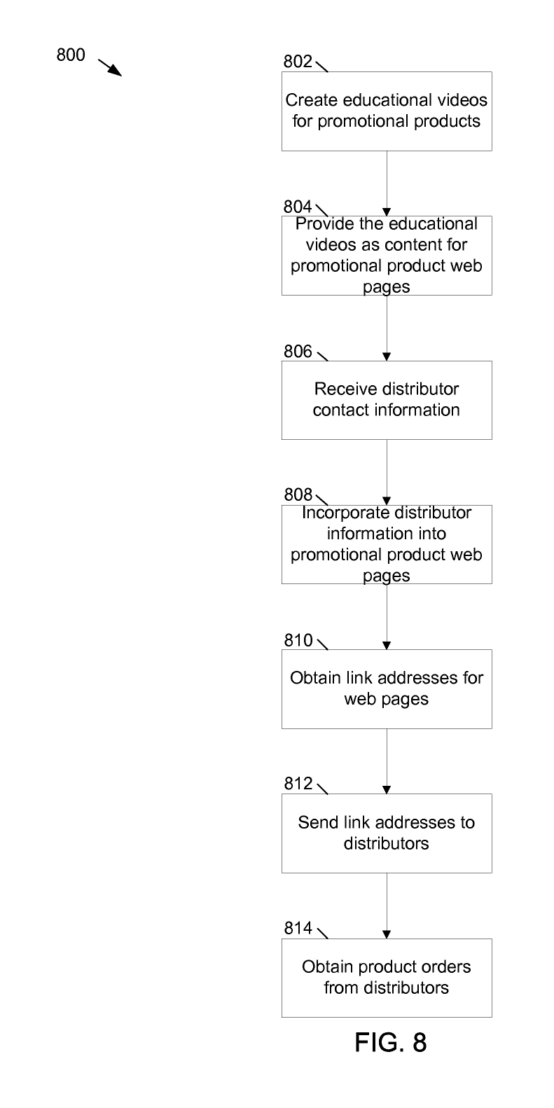

FIG. 8 shows an example flowchart of a method 800 at a supplier computer, for example at supplier computer 104, for developing sales for promotional products. At operation 802, educational videos are developed for one or more promotional products. The educational videos are developed by the supplier or manufacturer of the promotional products. The promotional products, for example binders, pens, calendars, etc. are sold to advertisers who in turn provide the promotional products to their customers as a way to promote sales. The videos provide educational information about the promotional products to the advertisers so the advertisers can make an informed purchase of the promotional products. The videos are usually supplier and distributor neutral, in that they do not identify any particular suppliers or distributors associated with the product.

At operation 804, the educational videos are provided to a web server that hosts a website for promotional products and that will include the educational videos on the website. For example, the educational videos may be uploaded to a database associated with the web server and an administrator of the web server may install the educational videos on the web server. The web server may host a generic website for promotional products. Alternatively, the web server may host a private-labeled website associated with a specific distributor of promotional products.

At operation 806, distributor contact information is received from one or more distributors. The distributor contact information typically includes the name, mailing address, email address and telephone number of the distributor.

At operation 808, the distributor contact information is provided to an administrator of the web server for incorporation into one or more private-labeled websites for promotional products hosted on the web server. Each private-labeled website hosted on the web server will have contact information for a different distributor that identifies the distributor. The intent of the private-labeled website is to permit a viewer of the website, typically an advertiser, to contact the distributor identified on the website.

At operation 810, a link address, typically a URL is received for the private-labeled website. For example, an email address may be received with the URL. Other means of communicating the link address are possible.

At operation 812, the link address for the private-labeled website is sent to the distributor associated with the website. The distributor then typically provides the link address to advertisers who have accounts with the distributor.

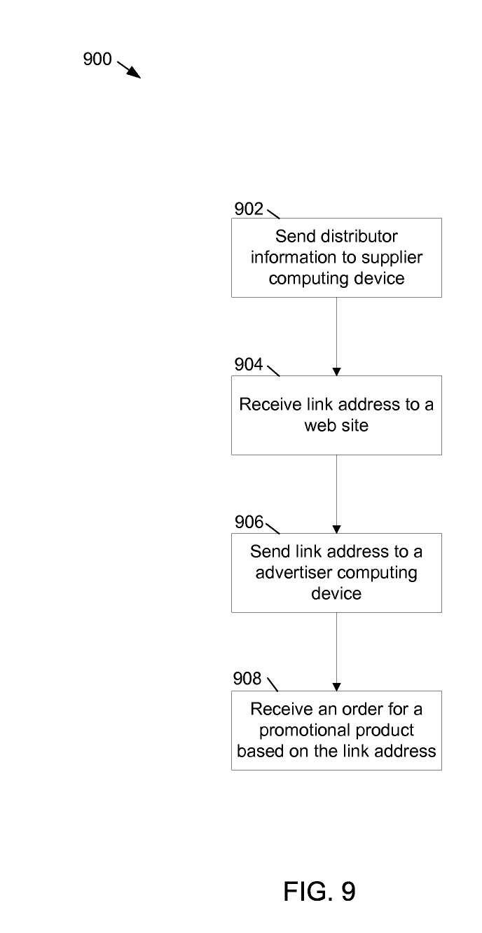

FIG. 9 shows an example flowchart of a method 900 at a distributor computer, for example at distributor computer 108, for developing sales for promotional products. At operation 902, distributor contact information is sent to a supplier, typically by including the contact information in an email sent from a distributor computer, for example distributor computer 108, to a supplier computer, for example supplier computer 104. The distributor contact information typically includes the name, mailing address, email address and telephone number of the distributor.

At operation 904, in response to sending the distributor contact information to the supplier, the distributor computer receives a link address, for example a URL, of a private-labeled website. The private-labeled website provides educational videos for promotional products and includes the distributor contact information.

At operation 906, the distributor sends the link address from the distributor computer to an advertiser computer, for example advertiser computer 112. The advertiser computer is associated with an advertiser that provides promotional products to customers of the advertisers. The advertiser uses the link address to access the private-labeled website, learn about promotional products available, and decide whether to purchase one or more promotional products.

At operation 908, the distributor computer receives a sales request for one or more promotional products. Because the private-labeled website only includes distributor contact information and does not include any identification of the supplier, the advertiser contacts the distributor to purchase the promotional products. In this manner, the supplier educates the advertiser about the promotional products but does not undercut the distributor.

In another possible example, distributors do not provide link information to an advertiser computing device. For example, a distributor utilizing a mobile computing device (such as a smartphone or tablet computer) may pull up a private-labeled website while visiting an advertiser in person. The advertiser can then view the promotional product video on the distributor's computing device. Similarly, if the advertiser is at the distributor's facility, the distributor's desktop computer could be used.

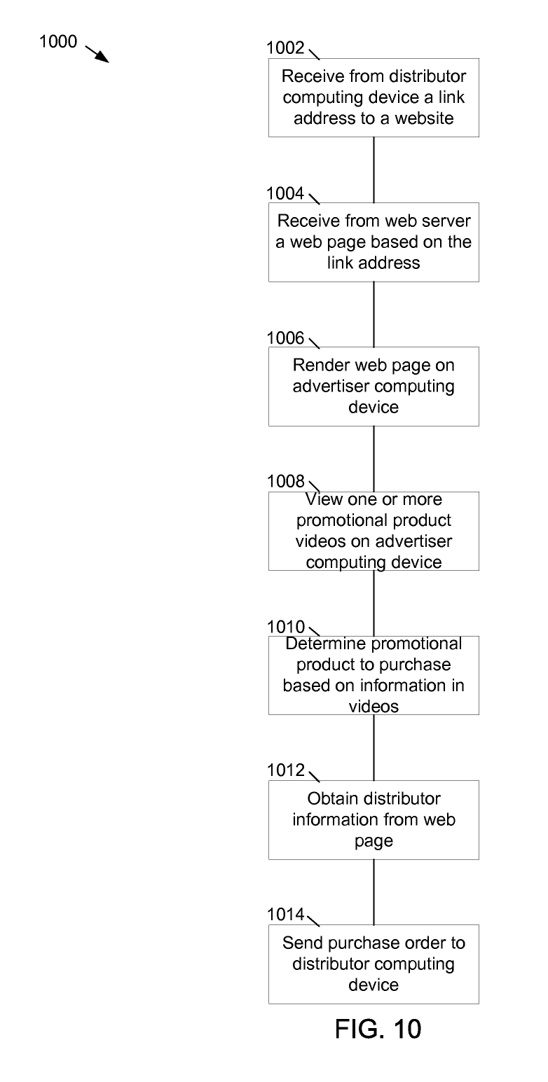

FIG. 10 shows an example flowchart of a method 1000 at an advertiser computer, for example at advertiser computer 112, for purchasing promotional products. At operation 1002, a link address to a private-labeled website is received at the advertiser computer from a distributor computer, for example from distributor computer 108.

At operation 1004, an advertiser at the advertiser computer accesses the private-labeled website specified by the link address and at operation 1006 views a promotional product web page at the advertiser computer. The promotional product web page is a home page, similar to the promotional products web page 200 from FIG. 2. As in FIG. 2, a video typically starts playing on a large display area on the web page.

At operation 1008, the advertiser views one or more educational videos on the private-labeled website. As discussed with respect to FIGS. 2, 3 and 4, the advertiser can select videos based on product or industry.

At operation 1010, the advertiser makes a determination as to whether to purchase one or more promotional products based on the information obtained from the educational videos on the private-labeled website.

When the advertiser makes a determination to purchase a promotional product, at operation 1012, the advertiser obtains the distributor contact information from the private-labeled web page. The advertiser may also click on a distributor contact button, for example button 238, to bring up an email screen with the distributor email address in the “To” field of the email screen. In examples, other “To” designations other than the string “To” may be used.

At operation, 1014, the advertiser sends a sales order for selected promotional products to the distributor computer.

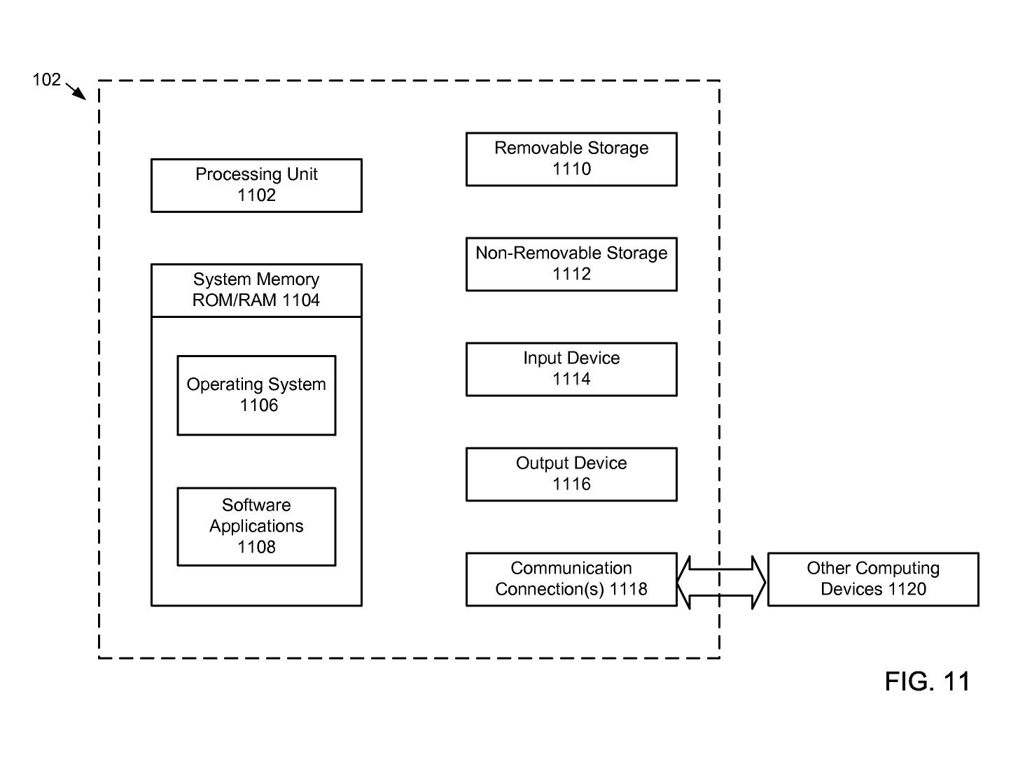

With reference to FIG. 11, example components of supplier computer 104 are shown. In example embodiments, the supplier computer is a computing device. The supplier computer 104 can include input/output devices, a central processing unit (“CPU”), a data storage device, and a network device. The distributor computer 108, the advertiser computer 112 and the web server computer 116 can be configured in a similar manner. In addition, any of the computers described herein can alternatively be multiple computers. Examples of possible computers include a server computer, a personal computer, a tablet or handheld computer, a smart phone, or other computing devices capable of processing data instructions. Tablet computers, handheld computers, and smart phones are examples of mobile computing devices. Some computers are web-enabled to permit data communication across a data communication network, such as the Internet.

In a basic configuration, the supplier computer 104 typically includes at least one processing unit 1102 and system memory 1104. Depending on the exact configuration and type of computing device, the system memory 1104 may be volatile (such as RAM), non-volatile (such as ROM, flash memory, etc.) or some combination of the two. System memory 1104 typically includes an operating system 1106 suitable for controlling the operation of a networked personal computer, such as the Windows® operating systems from Microsoft Corporation of Redmond, Wash. or a server, such as Microsoft Exchange Server 2007, also from Microsoft Corporation of Redmond, Wash. The system memory 1104 may also include one or more software applications 1108 and may include program data.

The supplier computer 104 may have additional features or functionality. For example, the supplier computer 104 may also include computer readable media. Computer readable media can include both computer readable storage media and communication media.

Computer readable storage media is physical media, such as data storage devices (removable and/or non-removable) including magnetic disks, optical disks, or tape. Such additional storage is illustrated in FIG. 11 by removable storage 1110 and non-removable storage 1112. Computer readable storage media may include volatile and nonvolatile, removable and non-removable media implemented in any method or technology for storage of information, such as computer readable instructions, data structures, program modules, or other data. Computer readable storage media can include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by supplier computer 104. Any such computer readable storage media may be part of the supplier computer 104. Some embodiments include non-transitory media. Supplier computer 104 may also have input device(s) 1114 such as keyboard, mouse, pen, voice input device, touch input device, etc. Output device(s) 1116 such as a display, speakers, printer, etc. may also be included.

The supplier computer 104 may also contain communication connections 1118 that allow the device to communicate with other computing devices 1120, such as over a network in a distributed computing environment, for example, an intranet or the Internet. Communication connection 1118 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The various embodiments described above are provided by way of illustration only and should not be construed to limiting. Various modifications and changes that may be made to the embodiments described above without departing from the true spirit and scope of the disclosure.

What is claimed is:

1. A method for developing sales for promotional items, the method comprising:
receiving with a computing device one or more educational videos for one or more promotional items available from a supplier;
using the educational videos as content on one or more web pages that provide information for the promotional items, the web pages being included on a website for the promotional items;
receiving distributor contact information from a distributor; and
incorporating the distributor contact information on at least one of the web pages, such that a viewer of the website can contact the distributor.

2. The method of claim 1 wherein, the web pages are free of information identifying the creator of the educational videos and the web pages are free of information identifying a supplier or manufacturer of the promotional items.

3. The method of claim 1 further comprising:
obtaining a link address for the website for the promotional items, the link address corresponding to a home web page for the website; and
sending the link address to the distributor.

4. The method of claim 3, further comprising obtaining from the distributor one or more orders for the promotional items.

5. The method of claim 1, wherein the distributor contact information includes a name, an email address, a telephone number and a logo for the distributor.

6. The method of claim 1, wherein the distributor contact information includes a link to a distributor website.

7. The method of claim 1, wherein the educational videos are directed towards a plurality of industries.

8. The method of claim 7, wherein the industries include one or more of automotive, manufacturing, insurance, hospitality, education, not-for-profit, government, real estate, manufacturing, construction, health, banking and restaurant.

9. The method of claim 1, further comprising sending the educational videos to the website.

10. The method of claim 1, further comprising sending one or more links to the educational videos to the website.

11. The method of claim 1, wherein the promotional items include free customer gifts, premium items and incentive items.

12. The method of claim 1, wherein the educational videos include product and pricing information.

13. The method of claim 1, wherein the educational videos include branding information from a third-party service provider.

14. The method of claim 1, wherein the website is a private labeled website that is associated with the distributor.

15. A method for developing sales for promotional items, the method comprising:
sending distributor contact information to a first electronic computing device;
receiving from the first electronic computing device a link address to a website that includes information for the promotional items available from a supplier, and includes the distributor contact information;
sending the link address to a second electronic computing device; and
receiving from the second electronic computing device an order for a promotional item.

16. The method of claim 15, wherein the information for the promotional items includes educational videos associated with the promotional items.

17. The method of claim 16, further comprising providing content to a consumer responsive to activation of the link address through the website, wherein the content, including the educational videos, are supplier neutral.

18. The method of claim 16, wherein the educational videos are provided as content on one or more web pages that provide information for the promotional items, the web pages being included on the website for the promotional items.

19. The method of claim 16, wherein the distributor contact information is incorporated on the one or more web pages but is not incorporated in the educational videos.

20. The method of claim 16, wherein the distributor contact information is incorporated in the educational videos.

21. An electronic computing device comprising:
a processing unit; and
system memory, the system memory including instructions that when executed by the processing unit cause the electronic computing device to:
create one or more educational videos for one or more promotional items, the educational videos being directed towards a plurality of industries, the industries including automotive, manufacturing, insurance and hospitality, the educational videos including product and pricing information, the promotional items including free gifts, premium items and incentive items;
use the educational videos as content on one or more web pages that provide product and pricing information for the promotional items, the web pages being included on a website for the promotional items, the website being a private labeled website associated with a distributor;
receive distributor contact information from the distributor, the distributor contact information including a name, email address, telephone number and logo for the distributor and a link to a distributor website;
incorporate the distributor contact information on at least one of the web pages, such that a viewer of the website can contact the distributor;
obtain a link address for the website for the promotional items, the link address corresponding to a home web page for the website;
send the link address to the distributor; and
obtain from the distributor one or more orders for the promotional items,
wherein, the web pages do not include any information identifying the creator of the educational videos and the web pages do not include any information identifying a supplier or manufacturer of the promotional items.

22. A method for developing sales for promotional items, the method comprising:
receiving with a computing device one or more educational videos for one or more promotional items available from a supplier;
using the educational videos as content on one or more display pages that provide information for the promotional items;
receiving distributor contact information from a distributor; and
incorporating the distributor contact information on at least one of the display pages, such that a viewer can contact the distributor.
